(19) United States
(12) Patent Application Publication
(10) Pub. No.: US 2015/0360426 A1
(43) Pub. Date: Dec. 17, 2015

(54) MANUFACTURE OF A MOULDED PART

(71) Applicant: HEXCEL HOLDING GMBH, Pasching (AT)

(72) Inventors: Joerg Radanitsch, Pasching (AT); Johannes Moser, Pasching (AT)

(73) Assignee: HEXCEL HOLDING GMBH, Pasching (AT)

(21) Appl. No.: 14/764,274

(22) PCT Filed: Feb. 25, 2014
(86) PCT No.: PCT/EP2014/053659

§ 371 Date: Jul. 29, 2015

(30) Foreign Application Priority Data
Feb. 26, 2013 (AT) A50124/2013

(51) Int. Cl. B29C 70/54; B29C 70/44

(52) U.S. Cl. CPC B29C 70/547; B29C 70/443; B29K 2063/00

(57) ABSTRACT

A method of manufacturing a laminate structure comprising locating one or more layers of a fibrous reinforcement material being at least partially impregnated with a curable first resin matrix in relation to one or more layers of fibrous reinforcement material to form a stack and subsequently infusing the stack with a second infusion resin to cure the first and second resin.

The present invention relates to a method of making a part, and a use, particularly but not exclusively to a method and a use relating to the manufacture of wind turbine parts and/or blades.

### BACKGROUND

As wind turbine blades increase in size, they require stacks of multiple layers of composite fibre and resin reinforcement. Conventionally, resin preimpregnated fibrous reinforcement (prepreg) is laid up in a mould to form these stacks. Alternatively, dry fiber layers are laid up in a mould and these are subsequently infused with a curable resin matrix using a vacuum assisted resin transfer moulding process (VARTM).

It is known in the art that bent fibers, linear distortion, wrinkles, or humps of fibres in a fibre-reinforced composite material greatly degrade the mechanical properties, particularly the strength and E-modulus, of the composite. Manufacturing of composites with highly aligned fibres is therefore very desirable. Particularly in VARTM lay-ups containing dry fiber layers, maintaining fiber alignment during both lay-up and processing is a problem.

### SUMMARY OF THE INVENTION

The present invention aims to obviate or at least mitigate the above described problem and/or to provide advantages generally.

According to the invention, there is provided a method and a use as defined in any of the accompanying claims.

In this way, fiber alignment can be maintained in the lay-up or stack and linear distortion of the fibers is prevented, as the resin preimpregnated fibrous reinforcement layers (prepreg) aid in the alignment of the fibers.

In a further embodiment, there is provided a use of a cured or partly cured fibre reinforced sheet material in a stack of one or more layers of a fibrous reinforcement material being at least partially impregnated with a curable first matrix resin forming a prepreg, said prepreg layers being located in relation to one or more layers of resin infusible fibrous reinforcement material to form said stack, to prevent linear distortion of the prepreg and/or infusible reinforcement material.

### SPECIFIC DESCRIPTION

Laminate parts may be formed from any combination of one or more layers of prepreg, dry fibrous material, and fiber reinforced sheet material. We will now discuss aspects of each of these layers below.

### Prepreg

Prepreg is the term used to describe fibres and fabric impregnated or in combination with a resin in the uncured state and ready for curing. The fibres may be in the form of tows or fabrics and a tow generally comprises a plurality of thin fibres called filaments. The fibrous materials and resins employed in the prepregs will depend upon the properties required of the cured fibre reinforced material and also the use to which the cured laminate is to be put. The fibrous material is described herein as structural fibre. The resin may be combined with fibres or fabric in various ways. The resin may be tacked to the surface of the fibrous material. The resin may partially or completely impregnate the fibrous material. The resin may impregnate the fibrous material so as to provide a pathway to facilitate the removal of air or gas during processing of the prepreg material.

One preferred family of resins for use in such applications are curable epoxy resins and curing agents and curing agent accelerators are usually included in the resin to shorten the cure cycle time. Epoxy resins are highly suitable resins although they can be brittle after cure causing the final laminate to crack or fracture upon impact and it is therefore common practice to include toughening materials such as thermoplastics or rubbers in the epoxy resin.

The cure cycles employed for curing prepregs and stacks of prepregs are a balance of temperature and time taking into account the reactivity of the resin and the amount of resin and fibre employed. The same applies to the resin infusion of dry fibrous layers.

From an economic point of view it is desirable that the cycle time be as short as possible and so curing agents and accelerators are usually included in the epoxy resin. As well as requiring heat to initiate curing of the resin the curing reaction itself can be highly exothermic and this needs to be taken into account in the time/temperature curing cycle in particular for the curing of large and thick stacks of prepregs as is increasingly the case with the production of laminates for industrial application where large amounts of epoxy resin are employed and high temperatures can be generated within the stack due to the exotherm of the resin curing reaction. Excessive temperatures are to be avoided as they can damage the mould reinforcement or cause some decomposition of the resin. Excessive temperatures can also cause loss of control over the cure of the resin leading to run away cure.

Generation of excessive temperatures can be a greater problem when thick sections comprising many layers of prepreg are to be cured as is becoming more prevalent in the production of fibre reinforced laminates for heavy industrial use such as in the production of wind turbine structures particularly wind turbine spars and shells from which the blades are assembled. In order to compensate for the heat generated during curing it has been necessary to employ a dwell time during the curing cycle in which the moulding is held at a constant temperature for a period of time to control the temperature of the moulding and is cooled to prevent overheating this increases cycle time to undesirably long cycle times of several hours in some instances more than eight hours.

For example a thick stack of epoxy based prepregs such as 60 or more layers can require cure temperatures above 100° C. for several hours. However, the cure can have a reaction enthalpy of 150 joules per gram of epoxy resin or more and this reaction enthalpy brings the need for a dwell time during the cure cycle at below 100° C. to avoid overheating and decomposition of the resin. Furthermore, following the dwell time it is necessary to heat the stack further to above 100° C. (for example to above 125° C.) to complete the cure of the resin. This leads to undesirably long and uneconomic cure cycles. In addition, the high temperatures generated can cause damage to the mould or bag materials or require the use of special and costly materials for the moulds or bags.

In addition to these problems there is a desire to produce laminar structures from prepregs in which the cured resin has a high glass transition temperatures (Tg) such as above 80° C. to extend the usefulness of the structures by improving their resistance to exposure at high temperatures and/or high humidity for extended periods of time which can cause an undesirable lowering of the Tg. For wind energy structures a Tg above 90° C. is preferred. Increase in the Tg may be achieved by using a more reactive resin. However the higher the reactivity of the resin the greater the heat released during curing of the resin in the presence of hardeners and accelerators which increases the attendant problems as previously described.

The reactivity of an epoxy resin is indicated by its epoxy equivalent weight (EEW) the lower the EEW the higher the reactivity. The epoxy equivalent weight can be calculated as follows: (Molecular weight epoxy resin)/(Number of epoxy groups per molecule). Another way is to calculate with epoxy number that can be defined as follows: Epoxy number=100/epoxy eq.weight. To calculate epoxy groups per molecule: (Epoxy number×mol.weight)/100. To calculate mol.weight: (100×epoxy groups per molecule)/epoxy number. To calculate mol.weight: epoxy eq.weight×epoxy groups per molecule. The present invention is particularly concerned with providing a prepreg that can be based on a reactive epoxy resin that can be cured at a lower temperature with an acceptable moulding cycle time.

The present invention therefore provides a prepreg comprising a mixture of a fibrous reinforcement and an epoxy resin containing from 20% to 85% by weight of an epoxy resin of EEW from 150 to 1500 said resin being curable by an externally applied temperature in the range of 70° C. to 110° C.

In an embodiment of the present invention therefore provides a prepreg comprising a mixture of a fibrous reinforcement and an epoxy resin containing from 20% to 85% by weight of an epoxy resin of EEW from 150 to 1500 said resin being curable by an externally applied temperature in the range of 70° C. to 110° C., wherein the resin contains from 0.5 to 5 wt % of a urea curing agent, and the resin is cured in the absence of a dicyandiamide based hardener.

We have found that prepreg and its epoxy resin matrix has a reduced cure time, whilst providing good mechanical performance, a desirable Tg (glass transition temperature) and good mechanical performance in combination with the fibrous reinforcement of the prepreg. In a preferred embodiment the curing resin has a dynamic enthalpy of 150 joules per gram of epoxy resin or lower. This resin may be cured in less than ten hours, and preferably less than 8 hours.

This renders the prepreg as described herein particularly suitable to lay-ups in combination with dry fibrous layers and/or cured fiber reinforced sheet materials which are subsequently infused with a further resin.

We have found that such desirable prepregs and stacks of prepregs may be obtained using conventionally available epoxy resins if the epoxy resin is cured in the absence of a traditional hardener such as dicyandiamide and in particular we have found that these desirable prepregs can be obtained by use of a urea based curing agent in the absence of a hardener such as dicyandiamide. The relative amount of the curing agent and the epoxy resin that should be used will depend upon the reactivity of the resin and the nature and quantity of the fibre reinforcement in the prepreg. Typically from 0.5 to 10 wt % of the urea based curing agent based on the weight of epoxy resin is used.

The epoxy resin has a high reactivity as indicated by an EEW in the range from 150 to 1500 preferably a high reactivity such as an EEW in the range of from 200 to 500 and the resin composition comprises the resin and an accelerator or curing agent. Suitable epoxy resins may comprise blends of two or more epoxy resins selected from monofunctional, difunctional, trifunctional and/or tetrafunctional epoxy resins.

Suitable difunctional epoxy resins, by way of example, include those based on: diglycidyl ether of bisphenol F, diglycidyl ether of bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, glycidyl esters or any combination thereof.

Difunctional epoxy resins may be selected from diglycidyl ether of bisphenol F, diglycidyl ether of bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl amines, heterocyclic glycidyl imidines and amides, glycidyl ethers, fluorinated epoxy resins, or any combination thereof. Suitable trifunctional epoxy resins are available from Huntsman Advanced Materials (Monthey, Switzerland) under the tradenames MY0500 and MY0510 (triglycidyl paraaminophenol) and MY0600 and MY0610 (triglycidyl meta-aminophenol). Triglycidyl meta-aminophenol is also available from Sumitomo Chemical Co. (Osaka, Japan) under the tradename ELM-120.

Suitable tetrafunctional epoxy resins include N,N, N′,N′-tetraglycidyl-methylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY0720 and MY0721 from Huntsman Advanced Materials). Other suitable multifunctional epoxy resins include DEN438 (from Dow Chemicals, Midland, Mich.) DEN439 (from Dow Chemicals), Araldite ECN 1273 (from Huntsman Advanced Materials), and Araldite ECN 1299 (from Huntsman Advanced Materials).

The epoxy resin composition also comprises one or more urea based curing agents and it is preferred to use from 0.5 to 10 wt % based on the weight of the epoxy resin of a curing agent, more preferably 1 to 8 wt %, more preferably 2 to 8 wt %, more preferably 0.5 to 5 wt %, more preferably 0.5 to 4 wt % inclusive, or most preferably 1.3 to 4 wt % inclusive.

The prepregs of this invention are typically used at a different location from where they are manufactured and they therefore require handleability. It is therefore preferred that they are dry or as dry as possible and have low surface tack. It is therefore preferred to use high viscosity resins. This also has the benefit that the impregnation of the fibrous layer is slow allowing air to escape and to minimise void formation.

The urea curing agent may comprise a bis urea curing agent, such as 2,4 toluene bis dimethyl urea or 2,6 toluene bis dimethyl urea and/or combinations of the aforesaid curing agents. Urea based curing agents may also be referred to as “urones”.

Preferred urea based materials are the range of materials available under the commercial name DYHARD® the trademark of Alzchem, urea derivatives, which include bis ureas such as UR500 and UR505.

In an embodiment of the invention, the prepreg may comprise a resin system comprising an epoxy resin containing from 20% to 85% by weight of an epoxy of EEW from 150 to 1500, and 0.5 to 10 wt % of a curing agent, the resin system comprising an onset temperature in the range of from 115 to 125° C., and/or a peak temperature in the range of from 140 to 150° C., and/or an enthalpy in the range of from 80 to 120 J/g (Tₒₙₛₑₜ, Tₚₑₐₖ, Enthalpy measured by DSC(=differential scanning calorimetry) in accordance with ISO 11357, over temperatures of from −40 to 270° C. at 10° C./min). Tₒₙₛₑₜ is defined as the onset-temperature at which curing of the resin occurs during the DSC scan, whilst Tₚₑₐₖ is defined as the peak temperature during curing of the resin during the scan.

The resin system is particularly suitable for prepreg applications at which a desired cure temperature is below 100° C. The resin system may be processed to cure over a wide processing temperature range, ranging from 75° C. up to 120° C. Due to its low exothermic properties this resin can be used for large industrial components, suitable for the cure of thin and thick sections. It demonstrates a good static and dynamic mechanical performance following cure temperatures <100° C.

The structural fibres employed in lay-up both in the prepregs and as dry fibre reinforcement may be in the form of random, knitted, non-woven, multi-axial or any other suitable pattern. For structural applications, it is generally preferred that the fibres be unidirectional in orientation. When unidirectional fibre layers are used, the orientation of the fibre can vary throughout the prepreg stack. However, this is only one of many possible orientations for stacks of unidirectional fibre layers. For example, unidirectional fibres in neighbouring layers may be arranged orthogonal to each other in a so-called 0/90° arrangement, which signifies the angles between neighbouring fibre layers. Other arrangements, such as 0/+45/−45/90° are of course possible, among many other arrangements.

The structural fibres may comprise cracked (i.e. stretch-broken), selectively discontinuous or continuous fibres. The structural fibres may be made from a wide variety of materials, such as carbon, graphite, glass, metalized polymers, aramid and mixtures thereof. Glass and carbon fibres are preferred carbon fibre, being preferred for wind turbine shells of length above 40 metres such as from 50 to 60 metres. The structural fibres, may be individual tows made up of a multiplicity of individual fibres and they may be woven or non-woven fabrics. The fibres may be unidirectional, bidirectional or multidirectional according to the properties required in the final laminate. Typically the fibres will have a circular or almost circular cross-section with a diameter in the range of from 3 to 20 μm, preferably from 5 to 12 μm. Different fibres may be used in different prepregs used to produce a cured laminate.

Exemplary layers of unidirectional structural fibres are made from HexTow® carbon fibres, which are available from Hexcel Corporation. Suitable HexTow® carbon fibres for use in making unidirectional fibre layers include: IM7 carbon fibres, which are available as fibres that contain 6,000 or 12,000 filaments and weight 0.223 g/m and 0.446 g/m respectively; IM8-IM10 carbon fibres, which are available as fibres that contain 12,000 filaments and weigh from 0.446 g/m to 0.324 g/m; and AS7 carbon fibres, which are available in fibres that contain 12,000 filaments and weigh 0.800 g/m.

The structural fibres of the prepregs will be substantially impregnated with the epoxy resin and prepregs with a resin content of from 20 to 85 wt % of the total prepreg weight are preferred. The prepregs of the present invention are predominantly composed of resin and structural fibres.

The stacks of prepregs and dry fiber layers of this invention may contain more than 40 layers, typically more than 60 layers and at times more than 80 layers. Typically the stack will have a thickness of from 35 to 100 mm.

### Fiber Materials

As discussed, the fiber materials suitable for resin infusion contain unimpregnated fibers. These layers may comprise structural fibers in the form of random, knitted, non-woven, multi-axial or any other suitable pattern. For structural applications, it is generally preferred that the fibres be unidirectional in orientation. When unidirectional fibre layers are used, the orientation of the fibre can vary throughout the prepreg stack. However, this is only one of many possible orientations for stacks of unidirectional fibre layers. For example, unidirectional fibres in neighbouring layers may be arranged orthogonal to each other in a so-called 0/90 arrangement, which signifies the angles between neighbouring fibre layers. Other arrangements, such as 0/+45/−45/90 are of course possible, among many other arrangements.

The structural fibres may comprise cracked (i.e. stretch-broken), selectively discontinuous or continuous fibres. The structural fibres may be made from a wide variety of materials, such as carbon, graphite, glass, metalized polymers, aramid and mixtures thereof. Glass and carbon fibres are preferred. Carbon fibre, being preferred for wind turbine shells of length above 40 metres such as from 50 to 60 metres. The structural fibres, may be individual tows made up of a multiplicity of individual fibres and they may be woven or non-woven fabrics. The fibres may be unidirectional, bidirectional or multidirectional according to the properties required in the final laminate. Typically the fibres will have a circular or almost circular cross section with a diameter in the range of from 3 to 20 μm, preferably from 5 to 12 μm. Different fibres may be used in different prepregs used to produce a cured laminate.

Exemplary layers of unidirectional structural fibres are made from HexTow® carbon fibres, which are available from Hexcel Corporation. Suitable HexTow® carbon fibres for use in making unidirectional fibre layers include: IM7 carbon fibres, which are available as fibres that contain 6,000 or 12,000 filaments and weight 0.223 g/m and 0.446 g/m respectively; IM8-IM10 carbon fibres, which are available as fibres that contain 12,000 filaments and weigh from 0.446 g/m to 0.324 g/m; and AS7 carbon fibres, which are available in fibres that contain 12,000 filaments and weigh 0.800 g/m.

Preferably, the dry fiber material comprises glass fiber material. The dry fibre material preferably has an area weight in the range of from 400 to 2500 g/m², preferably from 600 to 2400 g/m², and more preferably from 1000 to 1200 g/m². The glass fiber material may comprise glass fiber filaments having a diameter in the range of from 1 to 20 μm, preferably from 10 to 15 μm. We have found that these relatively large diameter filaments aid resin infusion. This is particularly important for large structure such as for wind turbine blades or parts thereof.

### Fiber Reinforced Sheet Material

Advantageously, the lay-up may contain one or more partially or fully cured layers of a fiber reinforced sheet material.

In an embodiment of the invention the fibre reinforced sheet material may contain regions of fully cured resin adjacent to regions of uncured, partially cured resin or unimpregnated fibre. A fibre reinforced sheet material comprising fully cured and non-fully cured regions of resin provides improved integration into the cured stack.

The use of partially or fully cured fibre-reinforced sheet material allows for very high fibre content and highly aligned fibres in the sheets. Furthermore, the fact that the sheet is cured facilitates transportation of the sheets, as no special conditions, such as temperature range or humidity range, are required. In addition, the combination of the sheet shape with the cured state facilitates adjustment of the sheets to the shape of the mould without compromising the alignment, or in other words the straightness, of the fibres in the lay-up forming the composite member or part. This is particularly important to complex shapes such as an airfoil of wind turbine blade, where the desired fibre distribution is a complicated three-dimensional shape.

Elements of a desired shape may be cut from the sheet material to facilitate a particular lay-up to form a composite member or part.

In a highly preferred embodiment of the invention, at least some of the elements of cured fibre-reinforced sheet material are positioned as partially overlapping tiles so that a number of substantially parallel element edges are provided. This allows for positioning of the elements very close to the surface of the mould, and by adjusting the overlapping area between elements, almost any desired overall distribution of reinforcing fibres may be realised. Particularly, the elements may be positioned in a cross section of a wind turbine blade so that the fibres substantially resemble the distribution of water in a lake having a depth profile corresponding to the distance from the centreline of the blade to the surface of the cross section. In a particularly preferred embodiment, the substantially parallel element edges are edges, which are substantially parallel to the length of the elements of cured fibre-reinforced sheet material. This leads to a relatively short resin introduction distance and hence easier manufacturing and greater reproducibility

The elements of cured fibre-reinforced sheet material may be provided along a shorter or a larger fraction of the length of the composite structure. However, it is typically preferred that the elements are positioned along at least 75% of the length of the wind turbine blade shell member, and in many cases it is more preferred that the cured fibre-reinforced sheet material is positioned along at least 90% of the length of the composite structure

The cured fibre-reinforced sheet material comprises fibres, such as carbon fibres, glass fibres, aramid fibres, natural fibres, such as cellulose-based fibre like wood fibres, organic fibres or other fibres, which may be used for reinforcement purposes. In a preferred embodiment, the fibres are unidirectional fibres oriented parallel to the length of the cured fibre-reinforced sheet material. This provides for very high strength and stiffness in the length of the cured fibre-reinforced sheet material. Other orientations or combinations of orientations may be suitable in some applications. Examples of other suitable orientations are bi-axial fibres oriented at +−45°, +−30°, or 0−90° relative to the length of the sheet material; and triaxial fibres oriented at +−45° and in the length of the sheet material. Such orientations increase the edgewise and/or twisting strength and stiffness of the composite material.

The structural fibres may comprise cracked (i.e. stretch-broken), selectively discontinuous or continuous fibres. The structural fibres may be made from a wide variety of materials, such as carbon, graphite, glass, metalized polymers, aramid and mixtures thereof. Glass and carbon fibres are preferred carbon fibre, being preferred for wind turbine shells of length above 40 metres such as from 50 to 60 metres. The structural fibres, may be individual tows made up of a multiplicity of individual fibres and they may be woven or non-woven fabrics. The fibres may be unidirectional, bidirectional or multidirectional according to the properties required in the final laminate. Typically the fibres will have a circular or almost circular cross-section with a diameter in the range of from 3 to 20 μm, preferably from 5 to 12 μm. Different fibres may be used in different prepregs used to produce a cured laminate.

Exemplary layers of unidirectional structural fibres are made from HexTow® carbon fibres, which are available from Hexcel Corporation. Suitable HexTow® carbon fibres for use in making unidirectional fibre layers include: IM7 carbon fibres, which are available as fibres that contain 6,000 or 12,000 filaments and weight 0.223 g/m and 0.446 g/m respectively; IM8-IM10 carbon fibres, which are available as fibres that contain 12,000 filaments and weigh from 0.446 g/m to 0.324 g/m; and AS7 carbon fibres, which are available in fibres that contain 12,000 filaments and weigh 0.800 g/m.

Furthermore, the cured fibre-reinforced sheet material comprises a sheet material resin, preferably a thermosetting resin, such as an epoxy-based, a vinyl ester-based resin, a polyurethane-based or another suitable thermosetting resin. The cured fibre reinforced sheet material may comprise more than one type of resin and more than one type of fibres In a preferred embodiment, the cured fibre-reinforced sheet material comprises unidirectional carbon fibres and an epoxy-based resin or a vinyl ester-based resin, preferably the cured fibre-reinforced sheet material consist substantially of unidirectional carbon fibres and an epoxy-based resin.

The resin material may comprise an epoxy resin having an epoxy equivalent weight in the range of from 50 to 250, preferably from 100 to 200, and an amine hardener, the resin material being in-line curable.

The reactivity of an epoxy resin is indicated by its epoxy equivalent weight (EEW) the lower the EEW the higher the reactivity. The epoxy equivalent weight can be calculated as follows: (Molecular weight epoxy resin)/(Number of epoxy groups per molecule). Another way is to calculate with epoxy number that can be defined as follows: Epoxy number=100/epoxy eq.weight. To calculate epoxy groups per molecule: (Epoxy number×mol.weight)/100. To calculate mol.weight: (100×epoxy groups per molecule)/epoxy number. To calculate mol.weight: epoxy eq.weight×epoxy groups per molecule. The present invention is particularly concerned with providing a prepreg that can be based on a reactive epoxy resin that can be cured at a lower temperature with an acceptable moulding cycle time.

The epoxy resin has a high reactivity as indicated by an EEW in the range from 150 to 1500 preferably a high reactivity such as an EEW in the range of from 200 to 500 and the resin composition comprises the resin and an accelerator or curing agent. Suitable epoxy resins may comprise blends of two or more epoxy resins selected from monofunctional, difunctional, trifunctional and/or tetrafunctional epoxy resins.

Suitable difunctional epoxy resins, by way of example, include those based on: diglycidyl ether of bisphenol F, diglycidyl ether of bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, glycidyl esters or any combination thereof.

Difunctional epoxy resins may be selected from diglycidyl ether of bisphenol F, diglycidyl ether of bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl amines, heterocyclic glycidyl imidines and amides, glycidyl ethers, fluorinated epoxy resins, or any combination thereof. Suitable trifunctional epoxy resins are available from Huntsman Advanced Materials (Monthey, Switzerland) under the tradenames MY0500 and MY0510 (triglycidyl paraaminophenol) and MY0600 and MY0610 (triglycidyl meta-aminophenol). Triglycidyl meta-aminophenol is also available from Sumitomo Chemical Co. (Osaka, Japan) under the tradename ELM-120.

Suitable tetrafunctional epoxy resins include N,N, N′,N′-tetraglycidyl-mxylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY0720 and MY0721 from Huntsman Advanced Materials). Other suitable multifunctional epoxy resins include DEN438 (from Dow Chemicals, Midland, Mich.) DEN439 (from Dow Chemicals), Araldite ECN 1273 (from Huntsman Advanced Materials), and Araldite ECN 1299 (from Huntsman Advanced Materials).

The cured fibre-reinforced sheet material is a relatively flat member having a length, which is at least ten times the width, and a width, which is at least 5 times the thickness of the sheet material. Typically, the length is 20-50 times the width or more and the width is 20 to 100 times the thickness or more. In a preferred embodiment, the shape of the sheet material is band-like.

It is preferred that the cured fibre-reinforced sheet material is dimensioned such that it is coilable. By coilable is meant that the sheet material may be coiled onto a roll having a diameter that allows for transportation in standard size containers. This greatly reduces the manufacturing cost of the composite member, as endless coils of the cured fibre-reinforced sheet material may be manufactured at a centralised facility and shipped to the blade assembly site, where it may be divided into elements of suitable size. To further enhance shipping, it is preferred that the thickness of the cured fibre-reinforced sheet material is chosen so that the cured fibre-reinforced sheet material may be coiled onto a roll with a diameter of less than 2 m based on the flexibility, stiffness, fibre type and fibre content utilised. Typically, this corresponds to a thickness up to 3.0 mm, however, for high fibre contents and stiffness, a thickness below 2.5 mm is usually more suitable On the other hand, the thick sheet materials provide for rather large steps at the outer surface, which favours the thinner sheet materials. However, the sheet materials should typically not be thinner than 0.5 mm as a large number of sheets then would be needed leading to increased manufacturing time. In a preferred embodiment, the thickness of the cured fibre-reinforced sheet material is about 15 to 2 mm.

The width of the cured fibre-reinforced sheet material typically varies along the length of the sheet material. Typically, the maximum width should be more than 100 mm and to reduce the number of sheets, a width of more than 150 mm is desirable. Experimental work has shown that in many cases, the width may preferably be more than 200 mm at the widest place. On the other hand, the resin must travel between adjacent sheets in length corresponding to the width of the sheet and hence the maximum width of the sheet material is preferably less than 500 mm to allow for suitable control of resin introduction. In a preferred embodiment, the maximum width is less than 400 mm and for example if the resin is selected so that it initiates curing prior to complete infusion, it is preferred that the maximum sheet width is less than about 300 mm.

In a preferred embodiment of the method according to the invention, the cured fibre reinforced sheet material is pre-treated before being positioned in the mould. Examples of pre-treatment is sandblasting, e.g. to increase the mechanical binding with the resin or to change the surface texture (see below), rinsing of the surfaces by mechanical and/or chemical means or acclimatising, e g. drying or heating. More than one type of pre-treatment of the cured fibre-reinforced sheet material may be suitable dependent on the conditions of the use.

The cured fibre-reinforced sheet material comprises highly aligned fibres and the cured fibre-reinforced sheet material may therefore advantageously be a pultruded cured composite material or a belt pressed cured composite. These techniques may provide the desired sheet shapes with a high fibre content of highly aligned fibres. Furthermore, these techniques are particularly suitable for manufacturing of endless lengths of material which are cut to the desired lengths.

The sheet material may have the following properties (refers to measurement standard):

| | | |
|---|---|---|
| Fibre volume fraction (%) | 57 to | 60; |
| Tensile strength (ISO527-5) (MPa) | 1600 to | 2000; |
| Tensile modulus (ISO527-5) (GPa) | 120 to | 150; |
| Tensile elongation (ISO527-5) (%) | 1.20 to | 1.33 |
| Flexural strength (ISO527-5) (MPa) | 2100 to | 2200; |
| Flexural modulus (EN2562) (GPa) | 120 to | 150; |
| Interlaminar shear strength (EN2563) (MPa) | 90 to | 100; |
| Compression strength (ASTM D6641) (MPa) | 1200 to | 1300; |
| Compression modulus (ASTM D6641) (GPa) | 120 to | 130; |

| | |
|---|---|
| Elongation (ASTM D6641) (%) | 0.99 |

The fiber volume fraction is the volume of the sheet material that is occupied by the fibers. The sheet may have an areal weight in the range of from 2000 to 4000 g/m², preferably from 2200 to 2800 g/m², more preferably 1500 g/m². The Tg of the resin matrix may be 100 to 150° C., preferably 110 to 140° C., more preferably 110 to 130° C.

The resin materials of the cured sheet material, prepreg and infusion resin are compatible with each other. Suitable combinations of resins are listed in the below Table 1. Preferably, the prepreg resin, sheet layer resin and infusion resin are all of the same resin type. More preferably, the prepreg resin and infusion resin are an epoxy resin and the sheet layer resin is a vinylester resin. All conventional types of resin or combinations of resins can be used, however, since they mix they should be compatible. Any resin suitable for use in the laminate is suitable for use in the prepreg and vice versa. The resins should be selected so that a good bond is formed between the cured sheet material and the infused resin and/or prepreg resin. A good bond can be determined by performing mechanical testing on cured parts, using established testing methods.

TABLE 1

| Component | Resin Type | Reinforcement |
|---|---|---|
| Prepreg Resin | Epoxy | Prepreg |
| | | Reinforcement |
| Sheet layer | Epoxy, Polyester, | Sheet |
| | Vinyl Ester, Poly | Reinforcement |
| | urethane | |
| Infused Component | Epoxy | Dry reinforcement |

### Processing and Curing

As discussed the materials are laid up in a mould in a desired sequence. The material may comprise combinations of one or more layers of prepreg, dry reinforcement and/or reinforced sheet materials.

Curing at a pressure close to atmospheric pressure can be achieved by the so-called vacuum bag technique. This involves placing the lay up stack in an air-tight bag and creating a vacuum on the inside of the bag. The bag may be placed in or over a mould prior or after creating the vacuum.

Infusion resin is supplied to the dry fiber layers by suitable conduits. The infusion resin or second infusion resin is drawn through the dry fibers by the reduced pressure inside the bag.

The first matrix resin inside the prepreg and the second infusion resin are then cured by externally applied heat to produce the moulded laminate or part. The use of the vacuum bag has the effect that the stack experiences a consolidation pressure of up to atmospheric pressure, depending on the degree of vacuum applied.

Upon curing, the stack becomes a composite laminate, suitable for use in a structural application, such as for example an automotive, marine vehicle or an aerospace structure or a wind turbine structure such as a shell for a blade or a spar. Such composite laminates can comprise structural fibres at a level of from 80% to 15% by volume, preferably from 58% to 65% by volume.

The invention has applicability in the production of a wide variety of materials. One particular use is in the production of wind turbine blades. Typical wind turbine blades comprise two long shells which come together to form the outer surface of the blade and a supporting spar within the blade and which extends at least partially along the length of the blade. The shells and the spar may be produced by curing the prepreg/dry fiber stacks of the present invention.

Advantageously the addition of cured sheet material to the stack reduces the peak temperature achieved during cure. Because the cured sheet material is precured it does not exotherm, instead it increases the total heat capacity of the stack. It can therefore be used in thick stacks to prevent high temperatures from being reached during cure which would otherwise damage the cured stack.

The length and shape of the shells vary but the trend is to use longer blades (requiring longer shells) which in turn can require thicker shells and a special sequence of materials within the stack to be cured. This imposes special requirements on the materials from which they are prepared. Carbon fibre based prepregs are preferred for blades of length 30 metres or more particularly those of length 40 metres or more such as 45 to 65 metres whilst the dry fiber is preferably a glass fiber. The length and shape of the shells may also lead to the use of different prepregs/dry fiber materials within the stack from which the shells are produced and may also lead to the use of different prepregs/dry fiber combinations along the length of the shell.

During vacuum assisted processing and curing, it may be very difficult to introduce resin between sheets of dry fiber material if the sheets are positioned very close. This is particularly the case if the space between the sheets is also subjected to vacuum.

In a preferred embodiment of the invention, the prepreg and/or the cured fibre reinforced sheet material is provided with a surface texture to facilitate introduction of resin between adjacent elements of prepreg and/or cured fibre-reinforced sheet material. The surface texture may comprise resin protrusions of a height above a main surface of the cured fibre-reinforced sheet material, preferably in the order of about 0.1 mm to 0.5 mm, preferably from 0.5 to 3 mm, but larger protrusions may in some cases, such as when the resin introduction distance is relatively large, be larger. The resin protrusions may be uncured, cured or partially cured.

The surface texture may in addition to this or as an alternative comprise recesses, such as channels into the main surface of the cured fibre-reinforced sheet material, preferably the recesses are in the order of 0.1 mm to 0.5 mm below the main surface, but in some cases larger recesses may be suitable. Typically, the protrusions and/or recesses are separated by 1 cm to 2 cm and/or by 0.5 to 4 cm, but the spacing may be wider or smaller dependent on the actual size of the corresponding protrusions and/or recesses.

Surface texture of the types described above may be provided after the manufacturing of the cured fibre-reinforced sheet material, e.g. by sanding, sand blasting, grinding or dripping of semi-solid resin onto the surface. But it is preferred that the surface texture to facilitate introduction of resin between adjacent elements of cured fibre-reinforced sheet material at least partially is provided during manufacturing of the cured fibre-reinforced sheet material. This is particularly easily made when the cured fibre-reinforced sheet material is manufactured by belt pressing, as the surface texture may be derived via a negative template on or surface texture of the belt of the belt press. In another embodiment, a foil is provided between the belt and the fibre-reinforced sheet material is formed in the belt press. Such a foil may also act as a liner and should be removed prior to introduction of the cured fibre reinforced sheet material in the mould.

In a preferred embodiment, the facilitating effect of surface texture on the resin distribution during resin introduction is realised by providing a plurality of inner spacer elements between adjacent elements of the cured fibre-reinforced sheet material. The inner spacer elements may advantageously be selected from one or more members of the group consisting of a collection of fibres, such as glass fibres and/or carbon fibres, a solid material, such as sand particles, and a high melting point polymer, e.g. as dots or lines of resin. It is preferred that the inner spacer elements are inert during the resin introduction, and for example does not change shape or react with the introduced resin. Using inner spacer elements may be 15 advantageous in many cases, as it does not require any particular method of manufacturing of the cured fibre-reinforced sheet material or a special pre-treatment of the cured fibre-reinforced sheet material. The inner spacing elements are preferably in the size range of 0.1 mm to 0.5 mm and separated by typically 1 cm to 2 cm, but both the sizes and the spaces may be suitable in some cases. Typically, the larger the inner spacing element, the larger the spacing can be allowed.

Alternatively, one or more suitable spacers may be used to space the dry fibre material layers. A suitable space may comprise silicon paper. This may layer be removed following processing and curing of the stack.

As discussed, to facilitate the introduction of resin this process may advantageously be vacuum assisted. The method may comprise the step of forming a vacuum enclosure around the composite structure. The vacuum enclosure may preferably be formed by providing a flexible second mould part in vacuum tight communication with the mould. Thereafter a vacuum may be provided in the vacuum enclosure by a vacuum means, such as a pump in communication with the vacuum enclosure so that the resin may be introduced by a vacuum assisted process, such as vacuum assisted resin transfer moulding, VARTM. A vacuum assisted process is particularly suitable for large structures, such as wind turbine blade shell members, as long resin transportation distances could otherwise lead to premature curing of the resin, which could prevent further infusion of resin. Furthermore, a vacuum assisted process will reduce the amount of air in the wind turbine blade shell member and hence reduce the presence of air in the infused composite, which increases the strength and the reproducibility.

The infusion resin must have a sufficiently low viscosity to achieve a complete infusion. Preferably the uncured resin has a viscosity between 100 and 200 cPoise, preferably from 120 to 140 upon mixing at 25° C. More specifically, the initial mix viscosity of the (infusion) resin may vary at 25° C. between 50 cPoise (ultralow viscosity resins) and 140 cPoise. After 4 hours at 25° C. the viscosity would be preferably be between 500 to 1000 cPoise, preferably between 550 to 650 cPoise. Preferably the infusion resin is an epoxy resin

The infusion resin may be curable at temperatures of from 60 to 100° C., preferably from 60 to 90° C., more preferably from 80 to 100° C. The resin may have a viscosity during the infusion phase of from 50 to 200 mPas, preferably from 100 to 160 mPas and more preferably of from 120 to 150 mPas. The neat infusion resin may have a density ranging of from 1.1 to 1.20 g/cm³; a flexural strength of from 60 to 150 N/mm2, preferably from 90 to 140 N/mm²; an elasticity modulus of from 2.5 to 3.3 kN/mm2, preferably from 2.8 to 3.2 kN/mm²; a tensile strength of from 60 to 80 N/mm², preferably from 70 to 80 N/mm²; a compressive strength of from 50 to 100 N/mm²; elongation at break of from 4 to 20%, preferably from 8 to 16% and/or combinations of the aforesaid properties.

An example of a suitable epoxy infusion resin is Epikote MGS RIM 135, as supplied by Hexion.

Composite parts or members according to the invention or manufactured by the method according to the invention may either form a wind turbine blade shell individually or form a wind turbine blade shell when connected to one or more further such composite members, e.g. by mechanical fastening means and/or be adhesive. From such wind turbine blade shells, a wind turbine blade may advantageously be 16 manufactured by connecting two such wind turbine blade shells by adhesive and/or mechanical means, such as by fasteners. Both the wind turbine blade shell and the combined wind turbine blade may optionally comprise further elements, such as controlling elements, lightning conductors, etc. In a particularly preferred embodiment, each blade shell consists of a composite member manufacturable by the method according to the invention. In another preferred embodiment, the wind turbine blade shell member manufactured by the method according to the invention forms substantially the complete outer shell of a wind turbine blade, i.e. a pressure side and a suction side which are formed integrally during manufacturing of the wind turbine blade shell member.

One aspect of the invention concerns a wind turbine blade comprising prepreg, resin infused dry fiber material and cured fibre-reinforced sheet material. The cured fibre reinforced sheet material is may be positioned near the outer surface of the blade as partially overlapping tiles.

In a preferred embodiment the cured fibre-reinforced sheet material is pultruded or band pressed cured fibre-reinforced sheet material and has been divided into elements of cured fibre-reinforced sheet material. In another preferred embodiment, a wind turbine blade according to the invention has a length of at least 40 m. The ratio of thickness, t, to chord, C, (t/C) is substantially constant for airfoil sections in the range between 75%<r/R<95%, where r is the distance from the blade root and R is the total length of the blade. Preferably the constant thickness to chord is realised in the range of 70%<r/R<95%, and more preferably for the range of 66%<r/R<95%.

This may be realised for a wind turbine blade according to the invention due to the very dense packing of the fibres in areas of the cross section of the blade, which areas provide a high moment of inertia. Therefore, it is possible according to the invention to achieve the same moment of inertia with less reinforcement material and/or to achieve the same moment of inertia with a more slim profile. This is desirable to save material and to allow for an airfoil design according to aerodynamic requirements rather than according to structural requirements.

### BRIEF DESCRIPTION OF THE DRAWINGS

The invention will now be clarified by way of example only and with reference to the following FIGURE.

FIG. 1 shows a diagrammatic cross-sectional view of 3 lay-ups comprising both prepreg and dry fabric layers.

FIG. 1 shows 3 lay-ups. The top lay-up (100) marked “infusion only” comprises two layers (102) of a dry fiber material which comprises LBB1200 fabric. LBB1200 is a 0°/+45°/−45° triax glass fabric of 1200 gsm fiber areal weight available from Hexcel Reinforcements (Villeurbanne, France). The 0° sides of the LBB1200 fabrics are in contact with one another. On either side of the layers (102) there is provided a non woven glass mat (104) having an areal weight of 50 gsm (style designation S5030 from Johns Manville, Waterville, Ohio). This material allows evacuation of the surfaces and this results in a good surface finish.

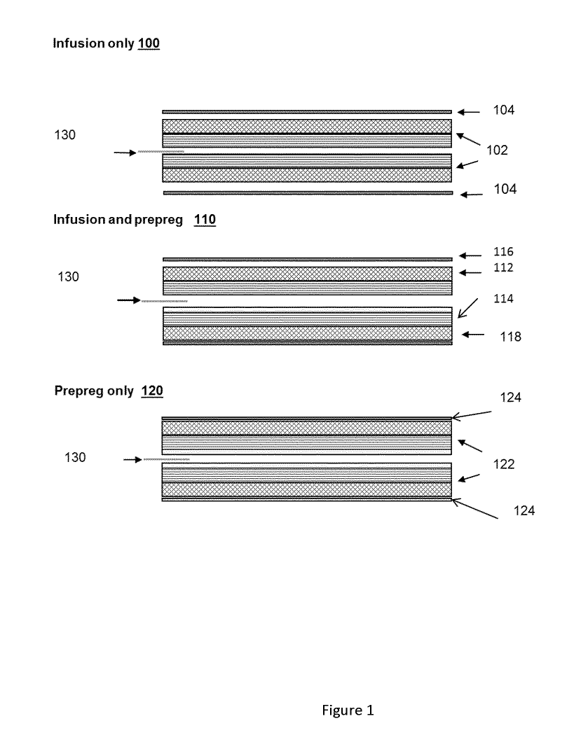

The second lay-up (110) marked “infusion and prepreg” comprises a layer of the dry fiber material (112) similar to layer (102), a prepreg layer (114) and the same nonwoven glass mat layers (116) and (118) similar to the layers (102,104). The prepreg (114) consists of the same LBB1200 fabric which is impregnated with M9.1 resin as supplied by Hexcel Corporation. The LBB1200 fabric contains 32% resin based on the weight of the prepreg. Again, the 0° sides of the LBB1200 fabrics are in contact with one another.

Finally, the third lay-up (120) marked “prepreg only” comprises two layers of the prepreg (122) as used in the second lay-up (110). Again, the 0° sides of the LBB1200 fabrics are in contact with one another. The same non-woven glass mat layers (124) are located on the prepreg layers (122).

In all lay-ups (100,110,120) the LBB1200 layers are separated by silicon papers (130) to promote infusion of the resin. The lay-ups were located with their glass mat side on a flat plate acting as a mould, and they were covered by a vacuum bag. For lay-ups (100,110) resin infusion conduits were provided. The stacks were evacuated and an infusion resin was provided via the infusion conduits. The infusion resin was prepared from 100 parts by weight 135 RIM as supplied by Hexion with 30 parts by weight of Hexion RIMH 137 hardener

The cure schedule was as follows: the temperature was increased from room temperature to a temperature of 80° C. at a heat up rate of 1.2° C./min. The temperature was then held at 80° C. for two hours. This was followed by an increase in temperature to 120° C. at a heat up rate of 1.2° C./min and the laminate stacks were held at this temperature for a further hour before they were allowed to cool down to room temperature.

The laminates were then tested for their compression strength in the 0° direction and their compression modulus in the 0° direction in accordance with standard ISO14126. 18

The results were as follows (see Table 2 below):

TABLE 2
Test results.

| | | Infusion | | Prepreg | Infusion/ | Infusion/prepreg |
|---|---|---|---|---|---|---|
| Lay-up | Infusion | (normalized) | Prepreg | (normalized) | prepreg | (normalized) |
| Compression | 690 | 710 | 1100 | 1120 | 940 | 890 |
| strength, 0 | | | | | | |
| deg (MPa) | | | | | | |
| Compression | 45 | 47 | 56 | 48 | 51 | 49 |
| modulus, 0 | | | | | | |
| deg (GPa) | | | | | | |

The results shown as normalized are based on a resin content of 35 wt % in relation to the laminate weight.

Lap shear tests were performed on cured reinforced sheet material having three different surface finishes.

The three surface finishes were:
A. Unfinished
B. Surface sanded with 80 grain abrasive paper
C. Laminate cured with peel ply which is removed

Polyspeed C-R150 laminates (Hexcel Corporation) were treated with one of the surface finishes A-C. Samples were formed by placing a layer of prepreg comprising 600 g/m² unidirectional carbon fabric and M79 resin between two layers of the surface finished laminate. The prepreg was then cured to bond the two laminate layers together.

The laminates were cut to size and the lap shear strength was measured in accordance with prEN 6060. Six samples were tested for each of the surface treatments A, B and C. The mean laps shear strength is listed in the below Table 3 for each sample set.

TABLE 3
Lap shear strength results for different surface treatments.

| | A. Unfinished | B. Sanded | C Peel Ply |
|---|---|---|---|
| | Surface | Surface | Treated Surface |
| Mean Lap Shear | 25.64 | 28.55 | 29.36 |
| Strength (MPa) | | | |

1. A method of manufacturing a laminate structure comprising forming a stack by locating one or more layers of a prepreg in relation to one or more layers of resin infusible fibrous reinforcement material, said prepreg comprising a fibrous reinforcement material that is at least partially impregnated with a curable first matrix resin and infusing the stack with a second infusion resin to cure the first matrix resin and second infusion resin.

2. A method according to claim 1, wherein the stack further comprises a cured or partly cured fiber reinforced sheet material comprising reinforcement, fibres and sheet material resin.

3. A method according to claim 1, wherein the stack comprises pathways between the prepreg and/or infusible fibrous reinforcement for conducting the second infusion resin through the stack.

4. A method according to claim 1, wherein the first matrix resin and second infusion resin are curable at a cure temperature of 60 or 70 or 80 or 90 or 100 or 120° C.

5. A method according to claim 1, wherein the second infusion resin comprises a pigment or dye.

6. A method according to claim 1, wherein the first matrix resin comprises an epoxy resin of EEW from 150 to 1500 said first matrix resin being curable by an externally applied temperature in the rare of 70° C. to 110° C.

7. A method according to claim 6, wherein the first matrix, resin has an EEW in the range of from 200 to 500.

8. A method according to claim 1, wherein the first matrix resin comprises from 0.5 to 10 wt %, based on the weight of the epoxy resin, of one or more urea based curing agents.

9. A method according to claim 1, wherein the first matrix resin has an onset temperature in the range of from 115 to 125° C.

10. A method according to claim 1, wherein the first matrix resin has a dynamic enthalpy of 150 joules per gram of epoxy resin or lower measured by DSC in accordance with ISO 11357 over temperatures of from −40 to 270° C. at 10° C./min.

11. A method according to claim 1, wherein the first matrix resin has an 80 to 120 J/g enthalpy measured by DSC in accordance with ISO 11357 over temperatures of from −40 to 270° C. at 10° C./min.

12. A method according to claim 2, wherein the cured or partly cured fibre-reinforced sheet material comprises a sheet material resin which comprises may comprise an epoxy-based resin, a vinyl ester-based or a polyurethane-based resin.

13. A method according to claim 2, wherein the prepreg and/or the cured or partly cured fibre reinforced sheet material is provided with a surface texture to facilitate introduction of said second infusion resin between adjacent elements of prepreg and/or cured or partly cured fibre-reinforced sheet material.

14. A method according to claim 2, wherein the cured or partly cured fibre reinforced material has a thickness up to 3 mm.

15. (canceled)
